(19) United States
(12) Patent Application Publication
(10) Pub. No.: US 2004/0200924 A1
(43) Pub. Date: Oct. 14, 2004

(54) Radio-controlled flying toy

(76) Inventors: Leonard R. Clark JR., Oreland, PA (US); H. Peter Greene JR., Boyertown, PA (US)

Correspondence Address: Michael de Angeli, 60 Intrepid Lane, Jamestown, RI, 02835, US

(21) Appl. No.: 10/763,283

(22) Filed: Jan. 26, 2004

Related U.S. Application Data
(60) Provisional application No. 60/443,720, filed on Jan. 29, 2003.

(51) Int. Cl. B64C 27/22

(52) U.S. Cl. 244/7 B

(57) ABSTRACT

A vertical take off and landing aircraft toy has a fuselage with a plurality of fins and a rotor assembly. The rotor assembly may be driven by an electric motor, powered by a battery, an air motor powered by compressed air, or a gasoline engine, radio controlled in each case to control the speed of the motor. The rotor assembly includes a head portion coupled to the motor output shaft, a central hub coupled to the head portion, and a pair of airfoil blades. The head portion allows pivoting of the central hub about an axis generally aligned with the axis of the blades, while the blades are pivotable with respect to the central hub about an orthogonal axis. The fins on the fuselage resist counterrotation of the fuselage with respect to the rotation of the blades; alternatively, a pair of counterrotating blades may be provided.

### CROSS-REFERENCE TO RELATED APPLICATIONS

This application claims benefit of U.S. Provisional Patent Application No. 60/443,720, “Remotely Controlled Vertical Flying Machines”, filed Jan. 29, 2003.

### BACKGROUND OF THE INVENTION

The present invention relates to remotely controlled toys and, in particular, to remotely controlled, electrically powered, vertical take off and landing aircraft toys, which are easy to successfully fly.

The prior art includes numerous flying toys, evidencing the interest in flight. Radio-controlled flying toys are of course well-known; perhaps best known are radio-controlled airplanes and helicopters powered by gasoline engines. While popular, these are not suitable for novices as they are expensive and difficult to learn to fly successfully; in particular, it is not easy to learn to land a powered aircraft successfully.

More recently, several air-powered model aircraft have appeared on the market. U.S. Pat. Nos. 6,006,517, 6,079,954 and 6,085,631 to Kownacki et al and U.S. Pat. No. 4,329,806 to Akiyama are all directed to improvements in motors for air-powered toys, including model airplanes. In general, such toys comprise a two- or three-liter plastic bottle, such as those in which soft drinks are sold, as air tanks, which can be repeatedly repressurized using a powered air compressor, a hand or foot-operated pump, or the like. The compressed air is then used to power a piston engine; a radio-controlled servo can be used to control an air supply valve, thus providing a throttle. Additional servos can then be provided to operate the other controls of the airplane. However, such toys are just as difficult to land successfully as gasoline-powered models. A flying toy that is simpler to fly successfully is still desired.

Vertical take and landing aircraft toys are known. For example, U.S. Pat. No. 6,550,715 to Reynolds et al discloses a model vertical take off and landing (VTOL) aircraft comprising an electric motor contained within a cylindrical housing. The motor, which operates on electrical charge stored by a capacitor, drives a propeller. A plurality of fins extend radially from the motor housing. A blade guard ring is connected to each of the fins via a corresponding plurality of posts. The blade guard is disclosed to protect the propeller should the aircraft strike a wall or the like. The fins operate to impart drag forces which tend to counterbalance torque imparted to the toy by the rotation of the propeller. Reynolds does not disclose the propeller blades having the ability to move relative to the rotor shaft driving the propeller blades for rotation, nor any sort of active control, e.g., by radio or infrared servo control devices.

U.S. patent application Publication No. 2003/0111575 to Rehkemper et al discloses a toy helicopter having a propeller assembly mounted to a rotor shaft for pivotal movement about orthogonal axes. The propeller can be driven by an air motor operating on compressed air sotrred in a tank within the fuselage of the toy. This mounting arrangement is disclosed to improve the stability of the toy when in flight. Rehkemper further discloses the propeller assembly comprising a safety ring or safety arcs to help prevent damage to the propeller blades should the blades impact a foreign object.

Finally, U.S. Pat. Nos. 5,879,131, 5,628,620 and 5,836,545 to Arlton and Arlton et al all relate to details of rotor structures for model helicopters.

A vertical take off and landing aircraft toy with improved stability which is easy to fly and land under control of an operator is not shown by the prior art known to the inventors, and would provide more engaging play activity than previous aircraft toys.

### BRIEF SUMMARY OF THE INVENTION

The present invention relates to a flying toy that is essentially a sui generis aircraft capable of vertical takeoff and landing, neither airplane or helicopter. See FIG. 1. A central fuselage 20 encloses a motor driving a rotor assembly 80 that is generally comparable to a helicopter rotor assembly, although it is simpler than the rotor assemblies used on modern “full-size” helicopters, as discussed further below.

When the toy is activated, that is, when the motor is operated to spin rotor assembly 80, the toy ascends essentially vertically. The fuselage 20 rotates in the direction opposite the direction of rotation of the rotor assembly 80. The rotation of fuselage 20 is reduced, and its flight made more stable, by provision of anti-rotation vanes 24 spaced around main body 10. In order that the spinning toy can take off and be landed successfully, a landing gear 50 comprising a number of flexible legs 56 attached to a central hub 54 is provided at the lower end of the fuselage 20. The landing gear 50 is connected to the fuselage 20 by a support bearing, so that the main fuselage 20 can rotate while the landing gear 50 is stationary, resting on the ground. The radio receiver and actuating servos can conveniently be located in central fuselage 20, keeping their weight low and further stabilizing the toy in flight.

The toy of the invention is disclosed in detail in electric-powered and air-powered embodiments. In the electric-powered embodiment, which is discussed in detail in connection with FIGS. 1-6, the fuselage contains an electric motor, rechargeable batteries, and a radio-controlled electronic speed control for controlling the operation of the motor. In the air-powered embodiment, disclosed in detail by FIGS. 7-8, the fuselage 20 serves as an air tank for supplying compressed air to an air motor driving rotor assembly 80. In this case, the radio receiver simply controls a servo opening an air valve, for example, comprising a ball moved along a tapered orifice by the servo, providing a throttle; to fly the toy, one simply operates a conventional radio transmitter to cause the servo to open the valve as desired. Alternatively, a gasoline engine could also be used, in which case of course the servo would be arranged to operate a throttle.

### BRIEF DESCRIPTION OF THE DRAWINGS

The invention will be better understood with reference to the accompanying drawings, in which:

FIG. 1 is a front perspective view of vertical take off and landing aircraft toy in accordance with a first electrically-powered embodiment of the present invention;

FIG. 2 is a top plan view of the aircraft toy of FIG. 1;

FIG. 3 a exploded view of the aircraft toy of FIG. 1;

FIG. 4 a front perspective detail view of a drive assembly of the aircraft toy of FIG. 1;

FIG. 5 is an upper perspective view of a propeller assembly of the aircraft toy of FIG. 1; and

FIG. 6 is a block diagram of electrical components of the aircraft toy of FIG. 1;

FIG. 7 is a perspective view of the air-powered embodiment of the toy of the invention;

FIG. 8 shows the arrangement of a radio receiver, servo, and throttle valve for the air-powered embodiment of FIG. 7; and

FIGS. 9 and 10 show a gearbox assembly used in a further alternative, applicable to both air- and electric-powered embodiments, in which counter-rotating rotors are provided.

### DETAILED DESCRIPTION OF THE INVENTION

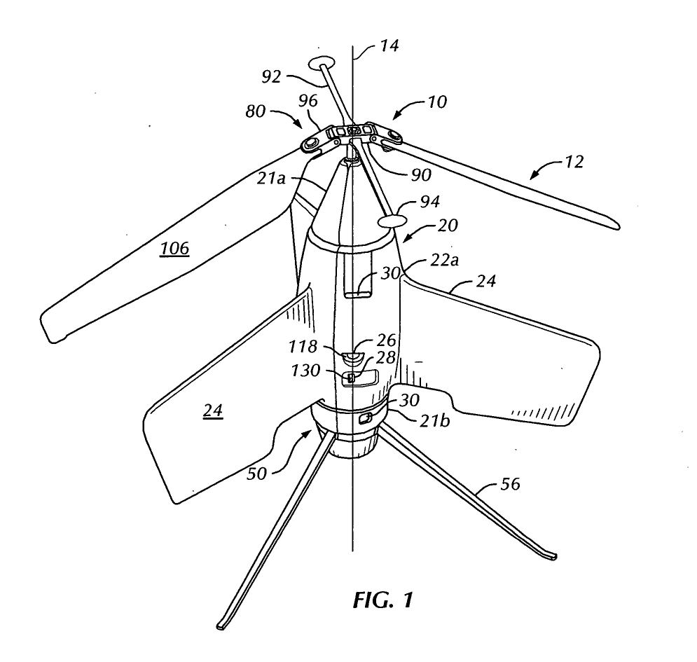

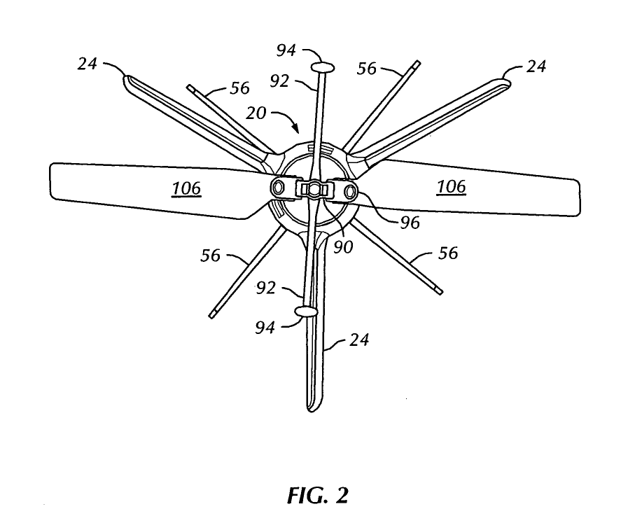

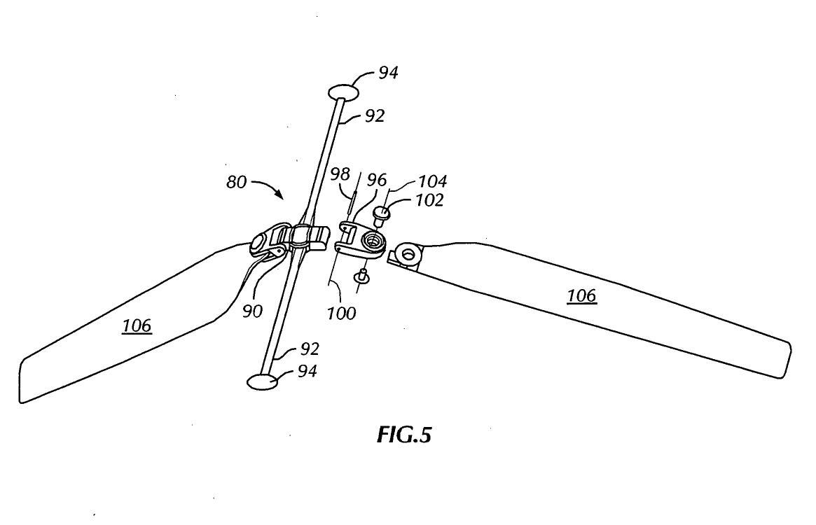

Referring to the drawings, wherein like reference numerals are used to designate the same components throughout the figures, FIGS. 1-6 show a vertical take off and landing aircraft toy 10 in accordance with a first electrically-powered preferred embodiment of the present invention. The major mechanical components of the toy aircraft 10 seen in FIGS. 1-5 are a fuselage 20, including a plurality of fins 24, extending generally radially outwardly from a central portion of the fuselage 20, a rotor assembly indicated generally at 80 and located at a first longitudinal end 21a of the fuselage 20, a landing gear assembly 50 located at a second opposing longitudinal end 21b of the fuselage 20, and a drive assembly 60 located within an upper portion of an interior of the fuselage 20. The toy is shown in its normal operating attitude, where the fuselage 20 is oriented vertically, with the rotor assembly 80 at its upper end. In the embodiment shown, the rotor assembly 80 includes a pair of airfoils or blades 106, which are pivotally mounted to a rotor hub 90 and which, when the hub is stationary, pivot downwardly under the action of gravity relative to the hub 90 into a stationary blade position as shown at 12.

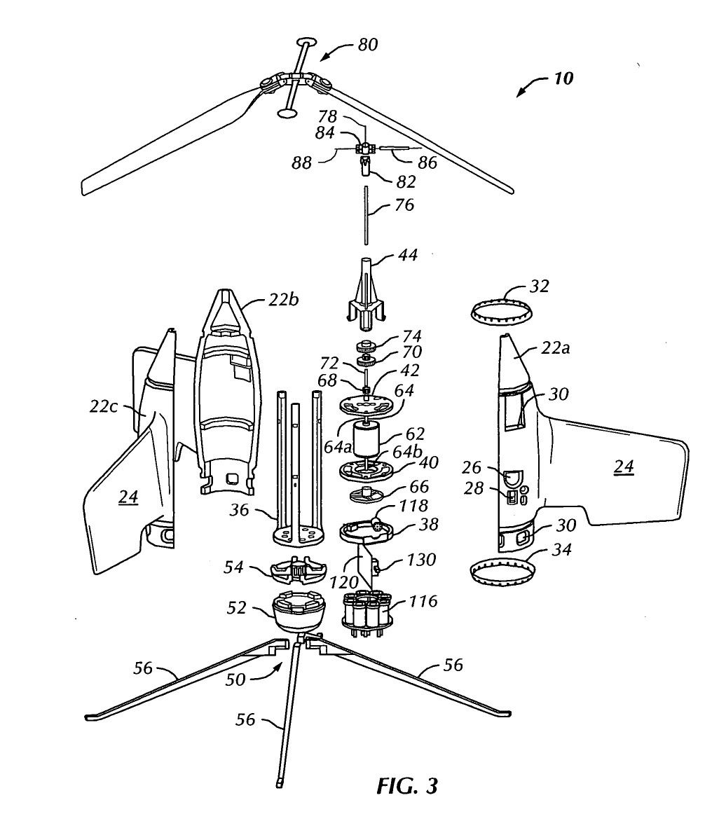

The fuselage 20 is elongated, so as to be streamlined or “bullet” or “capsule” shaped between its first and second longitudinal ends 21a, 21b. The fuselage 20 and toy aircraft 10 have a common central longitudinal axis 14 extending between the ends 21a, 21b. The fuselage 20 may be of a monocoque or frame and body construction. In the preferred embodiment shown, the fuselage 20 is an assembly formed from first, second and third body portions, 22a, 22b, and 22c, respectively, and a fuselage frame 36. (See FIG. 3.) The fuselage assembly 20 further includes a frame ring 38, a motor ring 40 and a motor mount 42, each of which connect with the fuselage frame 36. A rotor shaft support 44 is also connected to the fuselage frame 36. At least portions of the fuselage 20 are hollow to contain the electronics, power supply and motor drive of the toy aircraft 10, as will be described herein.

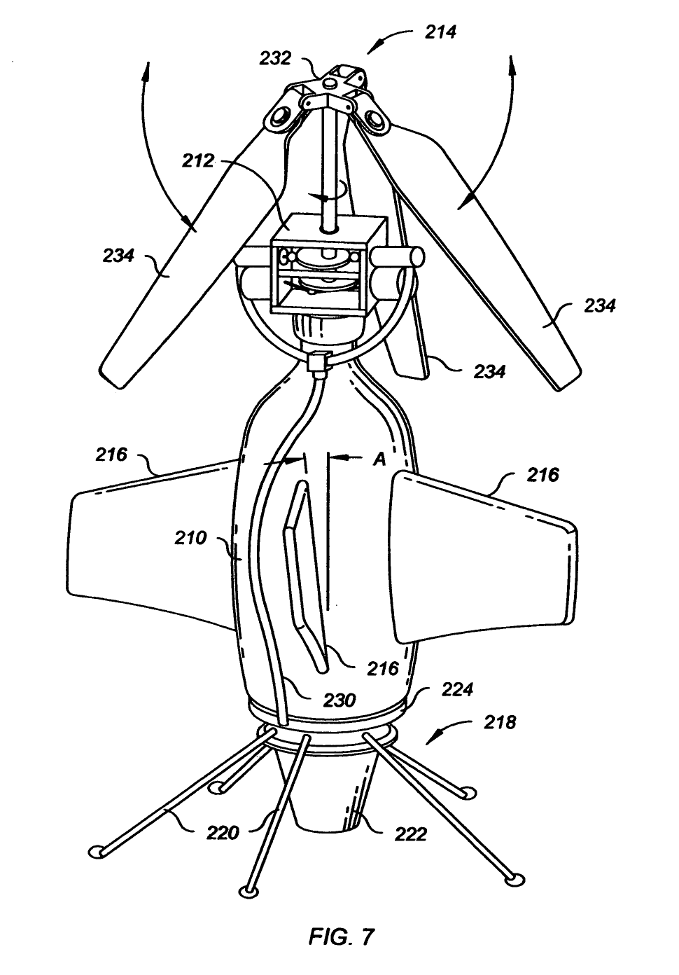

The fins 24 are preferably spaced uniformly about the central longitudinal axis 14. The fins 24 are elongated in an elongated direction of the fuselage 20 and extend generally longitudinally along and generally radially outwardly from the fuselage 20. The purpose of the fins 24 is to retard counter rotation of the fuselage 20 when the rotor assembly 50 is being rotated by a motor within the fuselage. Accordingly, the fins 24 desirably have a large surface area but are preferably of very light weight construction. The fins 24 are canted slightly from the central axis 14 in order to direct air flowing downwardly away from the rotor assembly 80 in one direction around the fuselage to enhance the counter-rotation function. (See FIG. 7.) In a preferred embodiment, the fins 24 are canted between about 1 degree and about 10 degrees with respect to the central longitudinal axis 14. While three fins 24 are shown and preferred, fewer or more than three fins may be provided.

For convenience in manufacturing, a fin 24 is preferably formed integrally with each of the first, second and third fuselage body portions 22a, 22b and 22c; the body portions including the fins 24 may be formed from a rigid yet lightweight foam material such as expanded polypropylene (EPP) foam. With reference to FIG. 3, in the preferred embodiment, the three fuselage body portions 22a, 22b and 22c are assembled around the fuselage frame 36 by an upper retainer ring 32 and a lower retainer ring 34. Thus, when the toy aircraft 10 is being assembled, e.g., by a consumer, the retainer rings 32, 34 are slid over the opposing ends 21a and 21b, respectively, and disposed in grooves formed in exterior surfaces of the body portions 22a-22c. The retainer rings 32, 34 are preferably formed from a polymeric material having good strength characteristics such as polypropylene.

In FIGS. 1 and 3, the first body portion 22a is shown to include a first opening 26 to allow access to a recharging connector 118 connected to a rechargeable battery power supply 116 and a second opening 28 to allow access to an on/off switch 130. The recharging connector 118 and on/off switch 130 are described later herein. Each of the body portions 22a, 22b and 22c includes vent holes 30 to allow air to circulate through the interior of fuselage 20.

With reference to FIGS. 1 and 3, the landing gear assembly 50 includes a landing cone 52, a landing gear hub 54 and a plurality of legs 56 extending away from the lower end 21b of the fuselage 20. The legs 56, preferably three or four, are provided to support the toy aircraft 10 with the fuselage 20 in an upright position as indicated in FIGS. 1-3. Preferably the legs 56 are uniformly spaced around central axis 14 and are releasably received into mating receptacles formed in the hub 54, again for convenience in assembly of the toy. Preferably the legs 56 have a resilient flexibility provided by their inherent construction so that they can safely absorb the impact of the toy aircraft 10 if it drops from altitude when it runs out of power, e.g., when the battery is fully discharged and the rotor stops spinning. The legs 56 and the hub 54 can be fabricated from a flexible, impact-resistant polymeric material such as acrylonitrile butadiene styrene (ABS) plastic. The landing cone 52 is preferably formed from a lightweight and durable material such as expanded polypropylene (EPP) foam.

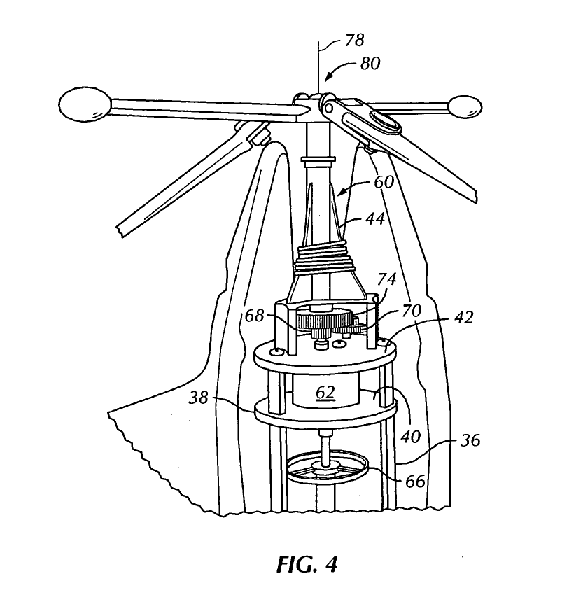

With reference now to FIGS. 3 and 4, the drive assembly 60 includes an electrically-powered drive motor 62, such as a model RC280 motor manufactured by Mabuchi Motor Company of Japan. The motor 62 is mounted to the motor mount 42. The motor 62 has a drive or output shaft 64 having first and second end 64a and 64b extending from opposing first and second ends of the motor 62 identified by those same reference numbers. A cooling fan 66 is attached to the output shaft 64 at the second end 64b, while a pinion gear 68 is attached to the output shaft 64 at the first end 64a. A rotor drive gear 74 is fixedly mounted to the rotor shaft 76 and is drivingly coupled with the pinion gear 68 through at least one reduction gear, a compound reduction gear 70, which is drivingly coupled between the pinion gear 68 and a rotor drive gear 74. The compound reduction gear 70 is supported for rotation on a stub shaft 72. The rotor drive shaft 76 rotates about an axis of rotation 78 which is preferably coincident with the central axis 14. The gears 68, 70 and 74 reduce the output from the motor 62 at a ratio of between about 8.5:1 and 11:1 to provide a rotor rotational speed of about 1,200 to 1,500 revolutions per minute.

With reference now to FIGS. 3-5, the rotor assembly 80 connects to and is driven for rotation by the rotor drive shaft 76. More particularly, a rotor head 82 (FIG. 3) is preferably mounted to a terminal end of the rotor drive shaft 76 by an interference fit. A rotor hub mount 84 is pivotally connected to the rotor head 82 by a hub mount pin 86, allowing the hub mount 84 and the attached blade assembly (further detailed below) to pivot about the rotor head 82 about an axis 88, extending along the long axis of the blades 106, through a pivot angle of about 15 degrees in each direction. The blade assembly includes a central rotor hub 90 coupled to the rotor drive shaft 76 by being releasably mounted to the rotor hub mount 84, preferably with an interference fit. That is, the rotor hub 90 is not pivoted with respect to hub mount 84, but pivots therewith about axis 88.

In the preferred embodiment shown, stabilizer bars 92, terminating in stabilizer masses 94, are fixed to and may be formed integrally with the rotor hub 90. While the stabilizer bars 92 and the pivoting of the blade assembly with respect to the fuselage provided by pivot pin 86 are not, strictly speaking, essential for operation of the toy aircraft 10, the stabilizer bars 92 have been shown to increase the stability of the toy aircraft 10 in flight. The stabilizer bars 92 are parallel and colinear with one another and extend generally radially from the central hub 90 and central axis 14 preferably alternated with airfoil blades 106 described below. The stabilizer masses 94, concentrating stabilizer bar weight as far as possible from the center of rotation, provide increased rotational inertia, for increased stability with the addition of minimal weight. The stabilizer bars 92 and masses 94 provide a load on the motor 62 and a gyroscopic effect that smoothes changes in the rotational speed of the rotor assembly 80.

The rotor assembly 80 includes two or more preferably identical airfoil blades 106 uniformly spaced about the central axis 14. The blades 106 are connected to the rotor hub 90 by a pair of blade mounts 96. Each blade mount 96 is hingedly connected at a first end with the rotor hub 90, allowing the blades to fold downwardly when not in use, and so as to pivot upwardly when rotated, and at a second opposing end with a blade 106, so that the blade can pivot if it impacts a solid member in flight.

More specifically, blade mounts 96 are essentially double clevis type connectors with a clevis at each of opposing first and second ends of each blade mount 96. A first clevis type pivot connection is made between the first end of the blade mounts 96 and the rotor hub 90 using a first pivot pin 98, allowing the blade 106 and blade mount 96 to pivot with respect to the rotor hub 90 about a first pivot axis 100, orthogonal to the pivot axis 88 defined by pin 86, allowing pivoting of the rotor hub 90 with respect to the drive shaft 76. A second clevis type pivot connection is made by a second pivot pin 102 at a second end of each blade mount 96 between the mount and each blade 106, allowing the blade 106 to pivot with respect to the blade mount 96 about a second pivot axis 104, orthogonal to axis 100. Furthermore, when the blades 106 are fully extended and co-planar as during flight, axes 100 and 104 are also generally perpendicular to the axis 88 about which the centravrotor hub 90 pivots with respect to the driveshaft 76. Provision of orthogonal axes 88 and 100, that is, allowing the blade/stabilizer assembly to move independently of the fuselage in two orthogonal directions, is generally conventional in helicopter blade assembly design (see, e.g., the Rehkemper published application referred to above), and provides improved stability in flight. As noted, provision of the third pivot axis 104, allowing the blades to swing rearward if they touch something during flight, provides principally a durability and safety improvement. By comparison, “full-size” helicopters typically are controlled by variation of the pitch angle of the blades, that is, their angle of attack, as they rotate; this degree of control is not provided by the toy in the preferred embodiments disclosed herein.

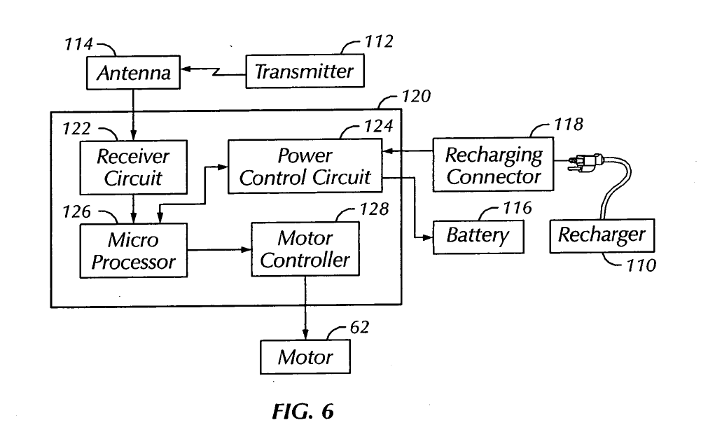

With reference now to FIGS. 3 and 6, a rechargeable battery 116 is coupled with electronic circuitry 120 and provides power to the motor 62. Preferably the rechargeable battery 116 is a nickel-metal-hydride (NiMH) battery. A portable battery recharger 110 is provided to allow convenient recharging of the battery 116 while the user is engaged in outdoor play activity, that is, in the field, away from an AC “house current” supply. The recharger 110 connects to the battery 116 via a recharging connector 118 disposed in the fuselage 20 and accessible via the first opening 26, and a power control circuit 124. Preferably, the recharger 110 comprises a conventional 12V sealed lead acid battery which can itself be recharged via a conventional AC/DC battery charger connected to an AC power source.

The electronic circuitry 120 is conventional and is preferably mounted on a circuit board. The circuitry 120 includes a receiver circuit 122, a power control circuit 124, a micro-processor 126 and a motor controller 128. An antenna 114 is operably coupled with the receiver circuit 122 to deliver signals received from a transmitter 112. The transmitter 112 is conventional, and preferably emits radio (wireless) signals. However, other types of controllers may be used including wired controllers and other wireless controllers (e.g. infrared, ultrasonic and/or voice-activated controllers), and the like. The power control circuit 124 is operably coupled with the recharging connector 118 and the battery 116. The motor controller 128 is operably coupled with the motor 62 to control operation of the motor 62.

In operation, a user charges the battery of recharger 110 using a 120 V AC power source. The user then proceeds to charge the onboard battery 116 by connecting the recharger 110 to the battery 116 via the recharger connector 118. After the recharger 110 is disconnected from the toy aircraft 10, the user proceeds to position the toy aircraft 10 in an upright position as illustrated in FIG. 1, turn the on/off switch 130 (FIG. 3) to an on position, and use the transmitter 112 to control speed of the motor 62 and consequently control flight of the toy aircraft 10.

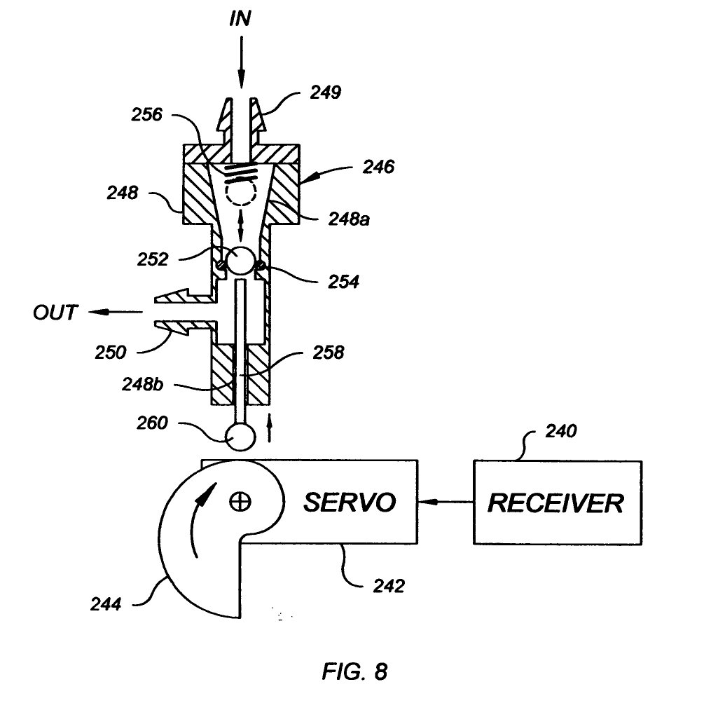

FIGS. 7 and 8 show a second embodiment of the invention, wherein the blades are driven by an air motor powered by compressed air stored in a tank comprised by the fuselage of the toy. Thus, in an air-powered embodiment of the toy of the invention, the main body 210 forms a tank for compressed air for powering an air motor 212. Main body 210 can simply comprise a two- or three-liter bottle as used to contain soft drinks; these are capable of holding more than 100 psi, while 80 psi is sufficient for a satisfactory flight of 20 to 30 seconds. A radio receiver and servo are mounted at the lower end of the main body, and may be concealed by a central member 222 forming part of the landing gear 218. The servo is arranged to operate a valve (discussed below in connection with FIG. 8) controlling flow of air from the main body 210 into a supply line 230.

The air motor 212 shown in FIG. 1 has two cylinders, disposed in opposed “boxer” configuration; various other arrangements are of course possible, but the opposed configuration is advantageous from the point of view of balance and ease of manufacture. Air motors are generally known in the art and are shown in the Kownacki and Akiyama patents, and the Rehkemper patent application, discussed above. The rotor assembly 214 is mounted directly to the output shaft of the air motor 212, as illustrated. The rotor assembly 214 comprises a central head 232 and a number of blades 234; three blades 234 are employed in the embodiment shown, as is typical. As conventional, blades 234 are hinged to rotor head 232, allowing their angles of attack to self-equalize, so that gusts of wind or the like do not cause instability as might occur with rigidly-connected blades. The two-blade rotor assembly discussed in connection with the FIGS. 1-6 embodiment above, with stabilizer bars and provided with freedom to pivot in orthogonal directions, is preferred over that shown in FIG. 7 for reasons of stability of the toy in flight.

As noted above, when the rotor assembly 214 is spinning, the main body and motor assembly spin in the opposite direction at a lower rate; in the absence of any restraint (including drag), this lower rate would bear the same proportion to the rate of spinning of the rotor assembly as the relative proportion of the moments of inertia of the rotor assembly and of the main body and motor assemblies, and little of the motor's torque would be available to lift the toy. Experiments carried out by the inventors show that anti-rotation vanes 216 are desirable to slow the rotation of the body and motor assembly, providing increased lift and better control. Essentially, the vanes 216 provide an anti-rotation force in two separate ways: (1) by being “barn doors” of relatively large surface area, they exert resistance to rotation through the ambient air, and (2) as the vanes 216 are inclined at a pitch angle A to the axis of the main body, the downwash from the rotor assembly also exerts an antirotation force on the vanes. In a currently preferred embodiment, four such vanes 216 are provided, spaced equally around the main body as shown, and bonded thereto at a slight pitch angle A, as indicated. Pitch angle A may typically be on the order of 1 to 10 degrees, as larger angles tend to interfere with the free flow of the downwash from the rotor, reducing lift. Similarly, the vanes 216 can be located low on main body 210, to stay as far away from rotor assembly 214 as possible in order to reduce their interference with airflow from the rotor assembly 214. Vanes 216 may be made of a lightweight relatively stiff material, such as a “minicell” crosslinked polyethylene foam.

In order that the toy of the invention can take off and be successfully landed while the main body continues to spin, it is necessary to provide a landing gear 218 that is capable of rotating with respect to the main body 210. In the embodiment shown, the landing gear 218 comprises a number, five in a successfully-tested embodiment, of struts 220 of a lightweight, resilient material such as fiberglass. Struts 220 are mounted to a central member 222, which in turn is journaled to main body 210 by a ball bearing 224 formed of plastic for light weight. Thus, when landing, struts 220 contact the ground, so that the landing gear 218 stops spinning with the main body 210, as it does during flight. The resilient struts 220 absorb the shock of landing, and the toy stands upright, ready to be “refueled”, by refilling main body 210 with compressed air, and flown again.

As noted above, it is generally desirable to keep the weight of the radio receiver, servo, and throttle valve assembly low, so as to serve as ballast stabilizing the toy in flight. Accordingly, these components are preferably mounted at the lower end of main body 210, and may be concealed by central member 222 of landing gear 218. FIG. 8 shows details of the throttle valve assembly. A conventional receiver 240 and servo 242 as used in various types of radio-controlled toys and the like are provided. A cam 244 mounted on the output shaft of the servo 242 is rotated by the servo in response to a command from the operator. A throttle valve 246 comprises a body 248 having an inlet port 249 connected to the air tank formed by main body 210 (FIG. 7) and an outlet port 250 connected to the air motor 212 (FIG. 7). A valve ball 252 is disposed in a generally tapered passage in valve body 248 connecting the inlet and outlet ports 249 and 250, and is biased toward an O-ring 254 forming the valve seat by a spring 256. A valve stem 258 extends out a closely-fitting passage 248a in valve body 248, and a cam follower 260 on its end is arranged to be contacted by cam 244. Thus, when cam 244 is rotated (clockwise in the drawing) by servo 242 in response to an operator command received by receiver 240, valve stem 258 forces ball 252 off seat 254, allowing air to flow from the inlet port 249 to the outlet port 250, powering the air motor; the tapered shape of the cavity 248a in which ball 252 fits assists in obtaining good control of the flow of air, and thus of the flight of the toy. A needle valve could also be employed to achieve similar good control of the flow of air.

Flying the toy of the invention is simply a matter of employing a radio transmitter to open the throttle valve as desired. Typically one opens the throttle for initial takeoff, and then adjusts the throttle to keep the toy hovering at a desired height. When the air pressure falls below a minimum value needed to operate the motor, the toy descends. However, it is sufficiently light—about 400 grams in a successfully-tested embodiment—that it lands softly on the landing gear and is unlikely to cause any damage or injury to anything on which it lands.

As noted, the air motor could be replaced by an electric motor powered by batteries, as in the FIGS. 1-6 embodiment, or by a gasoline-fueled engine, driving the rotor assembly through a reduction gear train, or possibly directly. However, the air motor embodiment shown has certain distinct advantages. An air motor is lighter, simpler and less expensive than either an electric motor and battery pack or a gasoline engine. An air motor operates at a speed suitable for driving a rotor assembly, so that reduction gears are not needed. An air motor can be refueled by operation of a hand- or foot-operated pump, essentially a conventional “bicycle” pump, so that batteries to power an electric motor do not have continually be replaced or recharged, and so that the complexities of dealing with a messy and flammable substance such as gasoline can be avoided. Indeed, the involvement of the operator, particularly when a child, in the act of refueling the toy by hand pumping is inherently more pleasing than replacing batteries or refilling a gasoline tank. Finally, it happens that the typical duration of a flight powered by air, which is on the order of 20-30 seconds in the prototypes tested thus far, is an appropriate duration given the degree of concentration required; that is, the degree of concentration required is such that a much longer flight time, as would presumbly be possible with a gasoline engine in particular, is not particularly desirable. Further, longer flights increase the possibility of the toy's being blown away from the user (since no directional control is provided) and increase the chance of damage or injury when the toy descends at the end of the flight.

Assuming that an air motor is selected to power the toy of the invention, the precise design of the air motor employed is subject to substantial variation. As mentioned above, an opposed-cylinder design is advantageous as being balanced and comparatively straightforward to manufacture. However, rotary engine configurations, e.g. with three or more cylinders spaced radially around the crankshaft, may also be used. A detailed disclosure of air motors in general is provided in the inventors' U.S. provisional patent application No. 60/421,777 filed Oct. 29, 2002, incorporated herein by reference, but the present invention is not limited thereto.

As mentioned above, in the embodiment of FIGS. 1-6, and also in that of FIGS. 7 and 8, anti-rotation fins or vanes (numbered 24 and 216, respectively) are needed in order to slow rotation of the main body and motor assembly in the opposite direction from the rotor assembly, so that most of the motor's torque is expended in spinning the blades, producing lift. As an alternative, a second rotor assembly coaxial with the first but rotating in the opposite direction could be provided; in this way the body would not rotate in reaction to the rotation of the blades, and all of the motor's torque would be expended in generating lift.

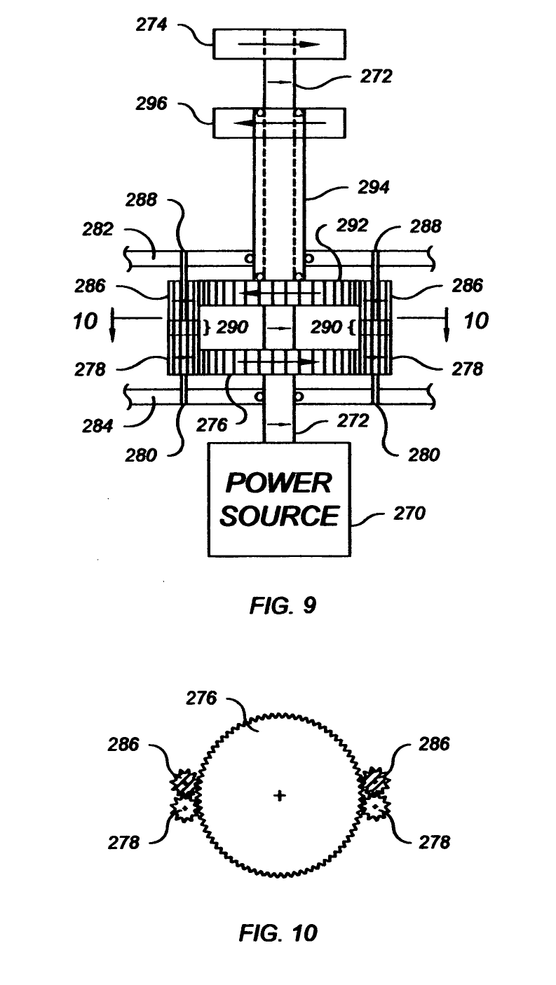

FIGS. 9 and 10 show a gearbox assembly that could be used to drive counter-rotating rotor assemblies in this way. FIG. 9 is an elevational view and FIG. 10 a section taken along line 10-10 of FIG. 3. In both, the teeth of the various gears are not shown, for clarity. As illustrated, the power source, whether an air or electric motor, or a gasoline engine, is indicated at 270, driving an input shaft 272 that also forms the driveshaft for a first rotor head 274. A first spur gear 276 is fixed to input shaft 272. Spur gear 276 drives a first pair of pinions 278, on its opposite sides to balance the loading. Pinions 278 spin on a first pair of axles 280, confined between upper and lower bulkheads 282 and 284, respectively. Pinions 278 mesh with and drive a second pair of pinions 286 similarly spinning on a second pair of axles 288. Pinions 278 and 286 mesh in areas 290, spaced away from first spur gear 276 and a second spur gear 292, which is driven by pinions 286. Second spur gear 292 is fixed to an output shaft 294 which is fixed to second rotor head 296. As indicated, the input shaft 272 and output shaft 294 are coaxial and journaled with respect to one another, and both are journaled with respect to the bulkheads through which they pass. Thus, a single power source can be used conveniently to power counter-rotating rotors, with advantages as noted above.

In a further modification, a second set of rotor blades, oriented oppositely to main blades 234, could simply be attached to the main body 210, in lieu of the anti-rotation vanes 216, and the body allowed to spin; the second set of blades would provide additional lift.

Manufacture of the toy according to the invention is believed to be within the skill of the art, given the above disclosure. The blades are preferably fabricated from a sturdy yet lightweight first polymeric plastic material, such as polypropylene. In an alternative embodiment, a leading edge of the blade could be formed from a second polymeric plastic material, having a lower durometer than the first polymeric material, and thus providing a cushioned leading edge.

While several preferred embodiments of the invention have been disclosed in detail, numerous further additional features will occur to those of skill in the art, and may be added without departure from the spirit and scope of the invention. For example, a second radio-controlled servo might be used to control additional functions, for example, the deployment of a parachute, as might be desirable to ensure safe landings. Therefore, the invention should not be limited by the above disclosure, which is exemplary only, but only by the following claims.

We claim:

1. A vertical take off and landing aircraft toy comprising:
a fuselage;
a source of power for a drive motor;
a drive motor having an output shaft, the drive motor receiving power from the source of power;
a control system regulating the operation of said drive motor responsive to a remotely-transmitted control signal;
a rotor assembly mounted at a first end of the fuselage and arranged to be driven by said drive shaft of said drive motor; and
a landing gear assembly mounted to a second end of the fuselage;
the rotor assembly including:
a rotor head fixed to said output shaft of said motor;
a central rotor hub; and
a pair of airfoil blades mounted on either side of said central rotor hub, said central rotor hub being pivoted to said rotor head about a first pivot axis orthogonal to said output shaft and generally aligned with the pair of airfoil blades, and said pair of airfoil blades being pivotally connected to said central rotor hub for pivoting about respective second axes at least generally perpendicular to the first pivot axis and orthogonal to said output shaft.

2. The vertical take off and landing aircraft toy of claim 1 further comprising a pair of stabilizer bars connected to and extending radially from the central rotor hub alternated with the airfoil blades.

3. The vertical take off and landing aircraft toy of claim 1 further comprising a pair of connectors interposed between said central rotor hub and the airfoil blades, wherein the connectors are of a double clevis type, such that said second pivot axis is defined between said central rotor hub and said connectors and a third pivot axis, perpendicular to said second pivot axis, is defined between said blades and said connectors.

4. The vertical take off and landing aircraft toy of claim 1 wherein said landing gear is rotatable with respect to said fuselage.

5. The vertical take off and landing aircraft toy of claim 1 wherein the landing gear comprises at least three legs extending away from the second end of the fuselage.

6. The vertical take off and landing aircraft toy of claim 1 wherein the fuselage is elongated between the first and second ends.

7. The vertical take off and landing aircraft toy of claim 6 wherein the elongated fuselage is bullet- or capsule-shaped.

8. The vertical take off and landing aircraft toy of claim 1 further comprising a plurality of fins extending generally radially outwardly from the fuselage, the fins being canted within a range of about 1 to about 10 degrees with respect to a central longitudinal axis of the fuselage.

9. The vertical take off and landing aircraft toy of claim 1 further comprising at least three fins extending generally radially outwardly from the fuselage, the fins being elongated in an elongated direction of the fuselage.

10. The vertical take off and landing aircraft toy of claim 1 wherein the power supply is a rechargeable battery and the drive motor is an electrically powered motor.

11. The vertical take off and landing aircraft toy of claim 10 further comprising at least one reduction gear drivingly coupled between the pinion gear and the rotor drive gear.

12. The vertical take off and landing aircraft toy of claim 1 wherein the motor is an air motor and the fuselage of the aircraft forms a tank for containing compressed air, forming the power supply for said air motor.

13. The vertical take off and landing aircraft toy of claim 1, comprising a second set of airfoil blades, mounted to be rotated about the same axis as said first set of airfoil blades, and a gearbox for driving said first and second sets of airfoil blades in opposite directions.

14. In combination, the vertical take off and landing aircraft toy of claim 1, and a transmitter for transmitting said control signal to said control system for regulating the speed of said motor.
